(19) United States
(12) Patent Application Publication
(10) Pub. No.: US 2012/0267508 A1
(43) Pub. Date: Oct. 25, 2012

(54) MOUNTING APPARATUS FOR FAN

(75) Inventor: GANG-QIANG QIN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/372,595

(22) Filed: Feb. 14, 2012

(30) Foreign Application Priority Data
Apr. 25, 2011 (CN) 201110103696.7

(51) Int. Cl. F16M 11/00

(52) U.S. Cl. 248/639

(57) ABSTRACT

A mounting apparatus for a plurality of fans includes a mounting bracket, a base and a stopper. The mounting bracket includes a mounting piece and a limiting post. The base, for securing the plurality of fans, includes a mounting portion, and a side of the base is rotatably mounted to the mounting bracket. The stopper is rotatably mounted to the base and defines a first sliding slot, a second sliding slot and a stop slot. The base is rotatable relative to the mounting bracket among a locked position, where the limiting post is engaged in the first sliding slot, and the mounting portion is secured to the mounting piece, a first unlocked position, where the mounting portion is disengaged from the mounting piece, and the limiting post is engaged in the stop slot, and a second unlocked position where the limiting post is engaged in the second sliding slot.

### BACKGROUND

1. Technical Field

The present disclosure relates to mounting apparatuses and particularly to a mounting apparatus for fan in a container server.

2. Description of Related Art

A plurality of fans is used in a container server for cooling the inner environment of the container server. Generally, the plurality of fans is secured to a mounting apparatus, and then the mounting apparatus is secured to a bracket in the container server. The mounting apparatus with the plurality of fans may be too heavy to be lifted and secured simultaneously by an operator. Lacking of a stop structure may cause the mounting apparatus to drop and injure the operator while securing the mounting apparatus.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a mounting apparatus and a plurality of fans.

FIG. 2 is an enlarged view of a circled portion II of FIG. 1.

FIG. 3 is an exploded, isometric view of the assembled mounting apparatus of FIG. 2 and the plurality of fans.

FIG. 4 is an isometric view of the assembled mounting apparatus of FIG. 1, and a base is in a locked position.

FIG. 5 is similar to FIG. 4, but the base is in a first unlocked position.

FIG. 6 is an isometric view of the assembled mounting apparatus and the plurality of fans of FIG. 1, and the base is in a second unlocked position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

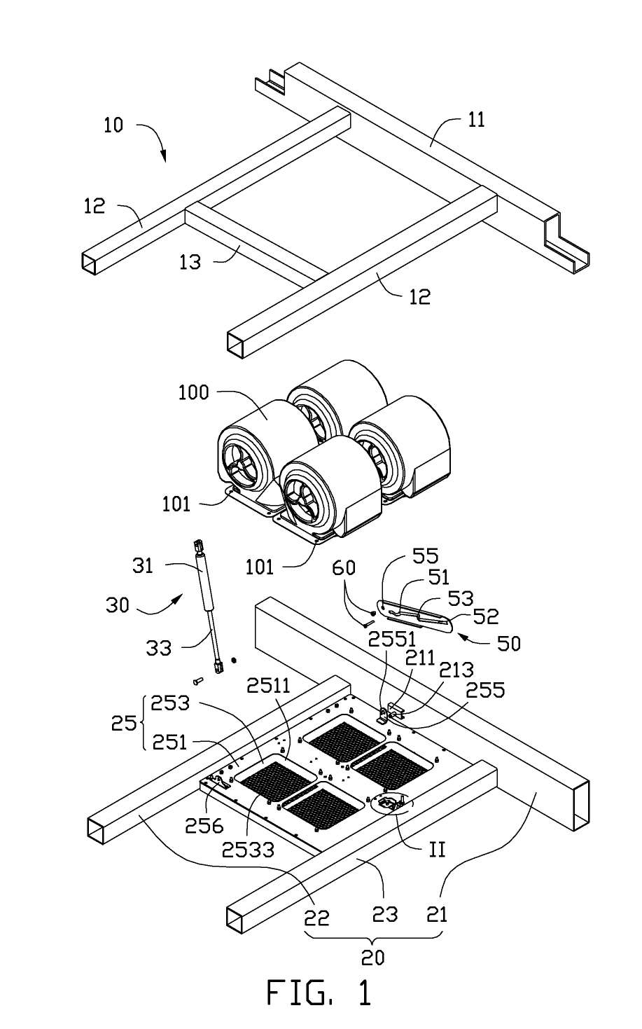

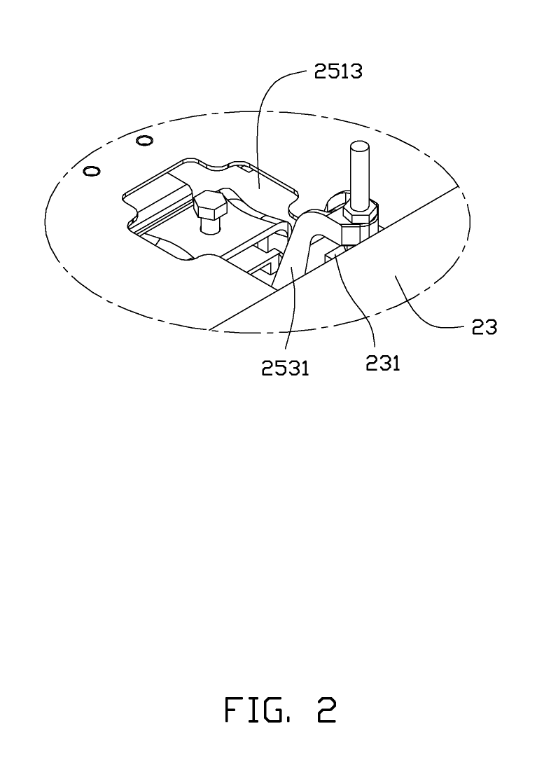

Referring to FIG. 1 and FIG. 2, a mounting apparatus in accordance with an embodiment for securing a plurality fans 100. The mounting apparatus includes a top frame 10, a mounting bracket 20, a base 25, a positioning member 30, and a stopper 50.

Each of the plurality of fans 100 defines a plurality of mounting holes 101.

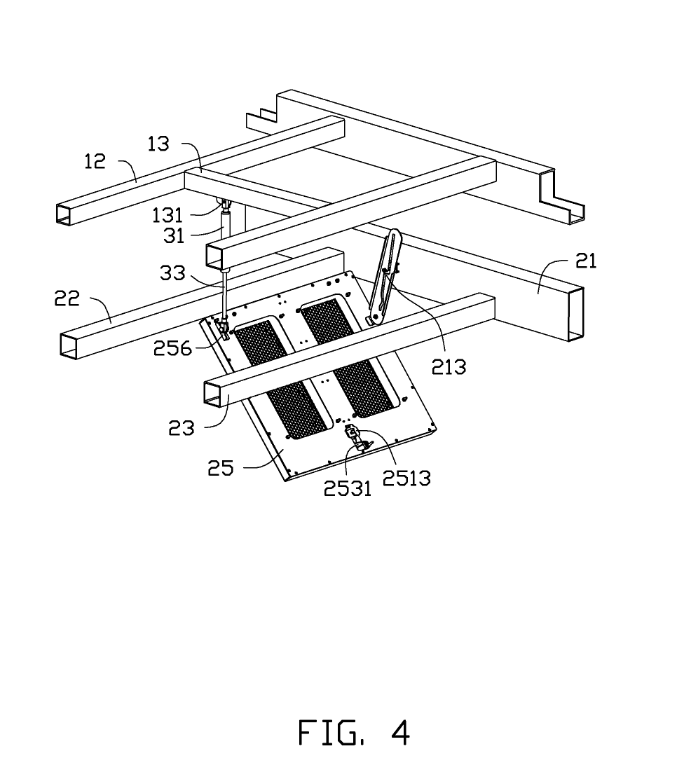

The top frame 10 includes a first mounting pole 11 and two first securing poles 12. In one embodiment, the two first securing poles 12 are substantially perpendicular to the first mounting pole 11. A maintaining pole 13 is secured between the two first securing poles. An installing piece 131 extends from the maintaining pole 13 for securing the positioning member 30 (shown as FIG. 4).

The mounting bracket 20 includes a second mounting pole 21, a second securing pole 22, and a third securing pole 23. In one embodiment, the second securing pole 22 and the third securing pole 23 are substantially perpendicular to the second mounting pole 21. A limiting piece 211 extends from the second mounting pole 21 and is located between the second securing pole 22 and the third securing pole 23. A limiting post 213 protrudes from the limiting piece 211 along a direction substantially perpendicular to the limiting piece 211. A mounting piece 231 extends from the third securing pole 23 and is substantially perpendicular to the third securing pole 23.

The base 25 includes a top plate 251 and a bottom plate 253 substantially perpendicular to the top plate 251. The top plate 251 defines an opening 2513 and a plurality of installing openings 2511 corresponding to the plurality of fans 100. A pivoting piece 255 and a positioning piece 256 are secured to the top plate 251. The pivoting piece 255 is located in a first end of the top plate 251 adjacent to the second mounting pole 21, and the pivoting piece 255 is adjacent to the limiting piece 211. A through hole 2551 protrudes from the pivoting piece 255 for pivotably mounting the stopper 50. A mounting portion 2531 is secured to the bottom plate 253. The mounting portion 2531 is elastic deformable and extends out of the opening 2513. The bottom plate 253 defines a plurality of air vents 2533 corresponding to each of the plurality of installing openings 2511.

The positioning member 30 includes an inflator 31 and a pole 33. In one embodiment, the positioning member 30 is a gas spring.

The stopper 50 defines a first sliding slot 51, a second sliding slot 52, and a stop slot 53 connected to the first sliding slot 51 and the second sliding slot 52. The first sliding slot 51, the second sliding slot 52 and the stop slot 53 communicate with each other. The stopper 50 further defines an installing hole 55 for the stopper 50 being secured to the pivoting piece 255.

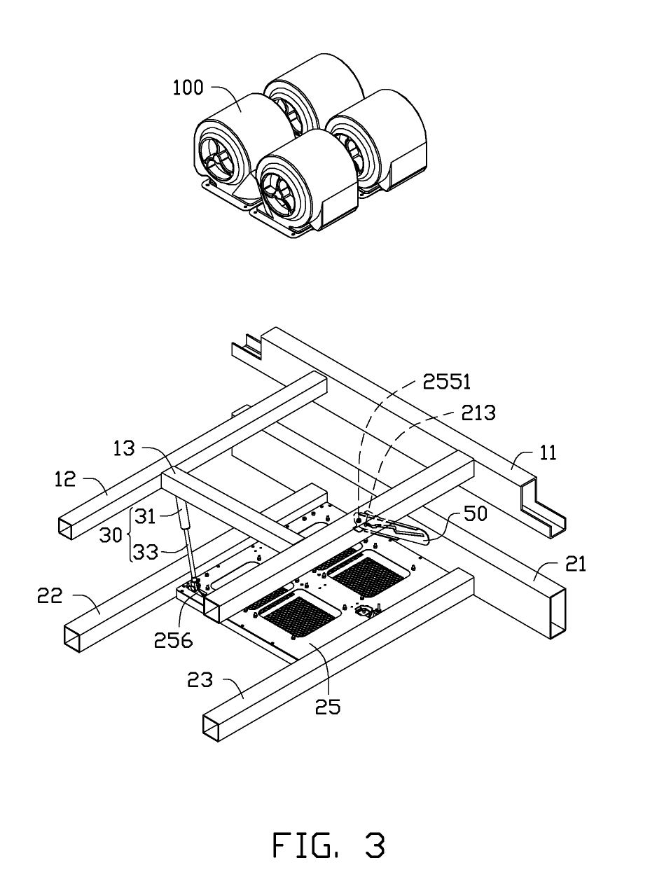

Referring to FIG. 3, in assembly, the top frame 10 and the mounting bracket 20 are secured to an inner surface of an enclosure. In one embodiment, the enclosure is a container server enclosure. The inflator 31 is secured to the installing piece 131. The pole 32 is rotatably mounted to the positioning piece 256. A first side of the base 25 is rotatably mounted to the second securing pole 22 by a hinge 26. A second side of the base 25, opposite to the first side, can be secured to the mounting piece 231 through the mounting portion 2531. The stopper 50 is moved adjacent to the second mounting pole 21, and the limiting post 213 is received in the first sliding slot 51 of the stopper 50. A shaft 60 is inserted into the installing hole 55 and the through hole 2551, and then the stopper 50 is rotatably attached to the limiting piece 211 about the shaft 60.

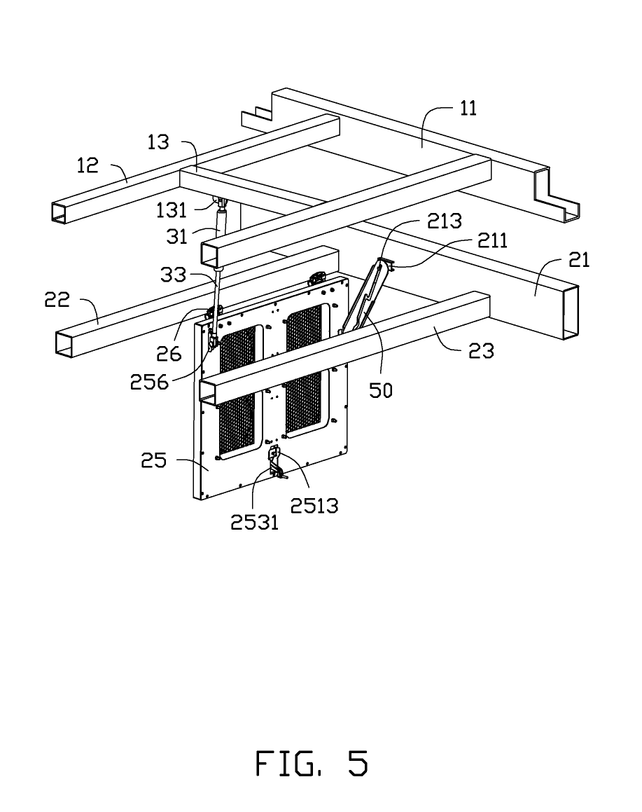

Referring to FIG. 4 and FIG. 5, the base 25 is rotatable among a locked position, a first unlocked position, and a second unlocked position. When the base is located in the locked position, the base is among the second mounting pole 21, the second securing pole 22 and the third securing pole 23. The mounting portion 2531 is engaged with the mounting piece 231. The limiting post 213 is engaged in an end of the first sliding slot away from the second sliding slot 52. In this position, the base 25 is located in a first panel, and the pole 33 extends out of the inflator with a first length. When the base 25 is in the first unlocked position, the mounting portion 2531 is disengaged from the mounting piece 231, the base 25 is disengaged from the third securing pole 23 and rotated away from the top frame 10 about the hinge 26. The limiting post 213 is engaged in the stop slot 53. The pole 33 is pulled out of the inflator with a second length, and the base 25 is in a second panel. A first angle is defined between the first panel and the second panel. In one embodiment, the first angle is substantially 45 degree. When the base 25 is in the second unlocked position, the base 25 is disengaged from the third securing pole 23 and rotated about the hinge 26 relative to the first unlocked position. The limiting post 213 is engaged in an end of the second sliding slot away from the first sliding slot 51, and the pole 33 is pulled out of the inflator with a third length. The base 25 is in a third panel. A second angle is defined between the second panel and the third panel. In one embodiment, the second angle is substantially 45 degree. The third length is larger than the second length. The second length is larger than the first length.

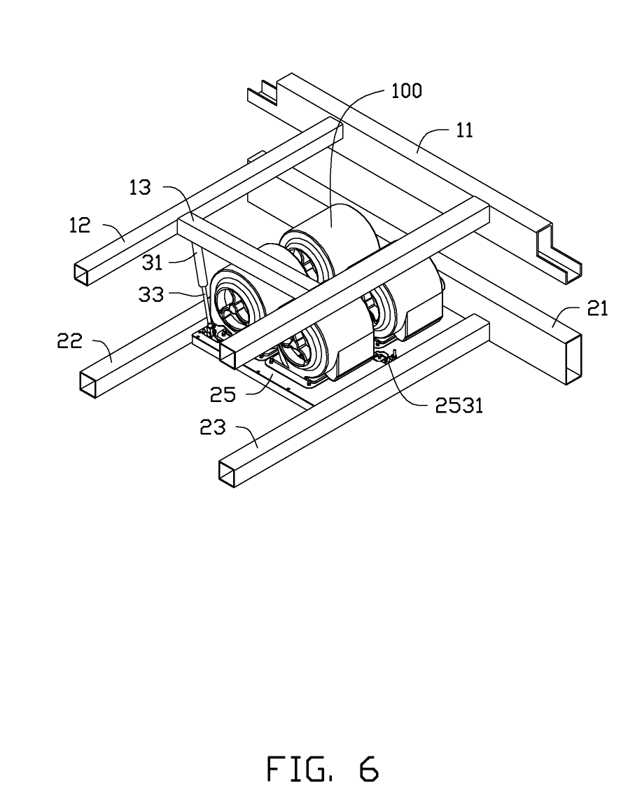

Referring to FIG. 6, in assembly of the plurality of fans 100, the base 25 is secured in the second unlocked position. The plurality of fans 100 are placed in the corresponding the plurality of installing openings 2511. A plurality of second locking members, such as screws, is inserted into the plurality of mounting holes 101 to secure the plurality of fans 100 to the base 25. The base 25 is rotated towards the top frame 10. The pole 33 is slid towards the inflator 31, and the stopper 50 is rotated relative to the base 25. The limiting post 213 is slid along the second sliding slot 52 relative to the stopper 50. Until the limiting post 213 is engaged in the stop slot 53, the base 25 is secured in the first unlocked position. The stopper 50 is rotated to disengage the limiting slot 213 from the stop slot 53 and located in the first sliding slot 51. The base 25 is rotated towards the top frame 10, the pole 33 is slid towards the inflator 31, the stopper 50 is rotated relative to the base 25, and the limiting post 213 is slid along the first sliding slot 51 relative to the stopper 50, until the mounting piece 231 is blocked by the mounting portion 2531. The mounting portion 2531 is elastically deformed to slide through the mounting piece 231. The mounting portion 2531 rebounds to engage to the mounting piece 231. The base 25 is located in the locked position.

In disassembly of the plurality of fans 100, the mounting portion 2531 is driven to elastically deformed to disengage from the mounting piece 231. The base 25 is rotated towards the mounting bracket 20. The pole 33 is pulled out of the inflator 31. The stopper 50 is rotated relative to the base 25. The limiting post 213 is slid along the first sliding slot 51 relative to the stopper 50, until the limiting post 213 is engaged in the stop slot 53. The base 25 is secured in the first unlocked position. The stopper 50 is driven to rotate to disengage from the stop slot 53 and slide into the second sliding slot 52. The base 25 is further rotated towards the mounting bracket 20. The pole 33 is further pulled out of the inflator 31. The stopper 50 is rotated relative to the base 25. The limiting post 213 is slid along the first sliding slot 51 relative to the stopper 50, until the base 25 is secured in the second unlocked position. The plurality of fans 100 can be removed from the base 25 then.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for a plurality of fans comprising:
a mounting bracket comprising a mounting piece and a limiting post;
a base, for securing the plurality of fans, comprising a mounting portion, and a side of the base rotatably mounted to the mounting bracket; and
a stopper rotatably mounted to the base and defining a first sliding slot, a second sliding slot and a stop slot connected to the first sliding slot and the second sliding slot;
wherein the base is rotatable relative to the mounting bracket in a locked position, where the limiting post is engaged in the first sliding slot, and the mounting portion is secured to the mounting piece; the base is in a first unlocked position, where the mounting portion is disengaged from the mounting piece, and the limiting post is engaged in the stop slot; and the base is in a second unlocked position where the limiting post is engaged in the second sliding slot; the base is located in a first panel when the base is in the locked position, the base is located in a second panel when the base is in the first unlocked position, and the base is located in a third panel when the base is in the second unlocked position; a first angle is defined between the first panel and the second panel, a second angle is defined between the first panel and the third panel, and the first angle is smaller than the second angel.

2. The mounting apparatus of claim 1, further comprises a top frame and a positioning member, the top frame comprises an installing piece, and the positioning member is secured to the installing piece.

3. The mounting apparatus of claim 2, wherein the top frame comprises a first mounting pole, two first securing poles and a maintaining pole, each of the two first securing poles is secured to the first mounting pole, and the maintaining pole is secured between the two first securing poles; and the installing piece extends from the maintaining pole.

4. The mounting apparatus for fan of claim 2, wherein the positioning member comprises an inflator and a pole, and the pole is slidably mounted to the inflator; the pole extends out of the inflator with a first length when the base is in the locked position, the pole extends out of the inflator with a second length when the base is in the first unlocked position, and the pole extends out of the inflator with a third length when the base is in the second unlocked position; and the third length is larger than the second length, and the second length is larger than the first length.

5. The mounting apparatus of claim 4, wherein the positioning member is a gap spring.

6. The mounting apparatus of claim 3, wherein a positioning piece extends from the base, the inflator is secured to the maintaining pole, and the pole is rotatably attached to the positioning piece.

7. The mounting apparatus of claim 1, wherein the mounting bracket further comprises a second mounting pole, a second securing pole and a third securing pole opposite to the second securing pole, a first side of the base is rotatably attached to the second securing pole, and the mounting portion is located on a second side of the base opposite to the first side.

8. The mounting apparatus of claim 7, wherein the limiting post is located on the second mounting pole and between the second securing pole and the third securing pole.

9. The mounting apparatus of claim 7, wherein the mounting piece extends from the third securing pole, the base is engaged with the third securing pole when the base is in the locked position, and the base is disengaged from the third securing pole when the base is in the first unlocked position or the second unlocked position.

10. The mounting apparatus of claim 7, wherein a pivoting piece extends from the base and defines a through hole, the stopper defines an installing hole, and a shaft is inserted into the installing hole and the through hole; and the stopper is rotatable relative to the base about the shaft.

11. A mounting apparatus for a plurality of fans comprising:
a top frame;
a mounting bracket comprising a mounting piece and a limiting post;
a base, for securing the plurality of fans comprising a mounting portion, and a side of the base rotatably mounted to the mounting bracket;
a stopper rotatably mounted to the base and defining a first sliding slot, a second sliding slot and a stop slot connected to the first sliding slot and the second sliding slot; and
a positioning member comprising an inflator and a pole slidably mounted to the inflator, the inflator secured to the top frame, and the pole rotatably attached to the base;
wherein the base is rotatable relative to the mounting bracket in a locked position, where the limiting post is engaged in the first sliding slot, the mounting portion is secured to the mounting piece, and the pole extends out of the inflator with a first length; the base is in a first unlocked position, where the mounting portion is disengaged from the mounting piece, the limiting post is engaged in the stop slot, and the pole extends out of the inflator with a second length; and the base is in a second unlocked position, where the limiting post is engaged in the second sliding slot, and the pole extends out of the inflator with a third length; and the third length is larger than the second length, and the second length is larger than the first length.

12. The mounting apparatus of claim 11, wherein the top frame comprises an installing piece, and the positioning member is secured to the installing piece.

13. The mounting apparatus of claim 12, wherein the top frame further comprises a first mounting pole, two first securing poles and a maintaining pole, each of the two first securing poles is secured to the first mounting pole, and the maintaining pole is secured between the two first securing poles; and the installing piece extends from the maintaining pole.

14. The mounting apparatus of claim 13, wherein a positioning piece extends from the base, the inflator is secured to the maintaining pole, and the pole is rotatably attached to the positioning piece.

15. The mounting apparatus for fan of claim 11, wherein the base is located in a first panel when the base is in the locked position, the base is located in a second panel when the base is in the first unlocked position, and the base is located in a third panel when the base is in the second unlocked position; a first angle is defined between the first panel and the second panel, a second angle is defined between the first panel and the third panel, and the first angle is smaller than the second angel.

16. The mounting apparatus of claim 11, wherein the positioning member is a gap spring.

17. The mounting apparatus of claim 11, wherein the mounting bracket further comprises a second mounting pole, a second securing pole and a third securing pole opposite to the second securing pole, a first side of the base is rotatably attached to the second securing pole, and the mounting portion is located on a second side of the base opposite to the first side.

18. The mounting apparatus of claim 17, wherein the limiting post is located on the second mounting pole and between the second securing pole and the third securing pole.

19. The mounting apparatus of claim 17, wherein the mounting piece extends from the third securing pole, the base is engaged with the third securing pole when the base is in the locked position, and the base is disengaged from the third securing pole when the base is in the first unlocked position or the second unlocked position.

20. The mounting apparatus of claim 17, wherein a pivoting piece extends from the base and defines a through hole, the stopper defines an installing hole, and a shaft is inserted into the installing hole and the through hole; and the stopper is rotatable relative to the base about the shaft.
